(19) United States
(12) Patent Application Publication
(10) Pub. No.: US 2011/0126589 A1
(43) Pub. Date: Jun. 2, 2011

(54) MOLD FOR MOLDED GLASS AND ITS PROTECTION METHOD

(76) Inventor: Yung-I CHEN, Keelung (TW)

(21) Appl. No.: 12/779,329

(22) Filed: May 13, 2010

(30) Foreign Application Priority Data
Nov. 30, 2009 (TW) 98140865

(51) Int. Cl. C03B 37/00; C03B 37/014

(52) U.S. Cl. 65/32.5; 65/157

(57) ABSTRACT

The present invention provides a mold for molded glass and its protection method; the protection method permits reducing gas to be generated within the mold for molded glass, thus preventing oxidation of core assembly during temperature rise of glass and protecting the core assembly; the reducing gas is formed by the reaction between oxygen and carbon-containing element in the mold; the mold comprises a core assembly, a core sleeve sleeved onto exterior of the core assembly and a reaction member, of which the reaction member made of graphite material is arranged onto exterior of the core sleeve or into the chamber of core assembly, and used to generate reducing gas from reaction with oxygen within the mold; moreover, the mold also comprises a core assembly, a core sleeve and a fixed molding ring; a carbon film is coated onto the inner side of the fixed molding ring, and the reducing gas is formed from reaction with oxygen within the mold space.

### BACKGROUND OF INVENTION

1. Field of the Invention

The present invention relates generally to a protection technology of the mold core for molded glass, and more particularly to a mold for molded glass and its protection method.

2. Description of Related Art

A conventional mold for molded glass generally comprises a core assembly, a core sleeve arranged on exterior of the core assembly and a press plate, etc; the core assembly consists of an upper core and a lower core, of which the upper core can shift under the drive of the press plate, and the glass is molded from the chamber formed between the molding surface of upper and lower cores. According to the common glass molding procedure, the preformed body of the glass is placed into the chamber of the mold; then, as the viscosity of glass material decreases with the temperature rise, the mold is heated up to the degree between transition temperature (Tg) and softening point in proper environment, and the glass is molded by pressing the preformed glass body with the upper core; next, the core shape is transformed, and the pressure is removed after cooling (upper core ascending) to take out the finished product.

To prevent the damage of molding surface of upper and lower cores arising from the reaction between the glass material and the upper/lower cores, the molding surface of the upper and lower cores is generally coated with a hard film, which is classified into precious metal alloy film or diamond like carbon film (DLC). The precious metal alloy film, such as: Pt—Ir, Ir—Re alloy film, is characterized by that no chemical reaction with the glass occurs; given the expensive materials, cost-efficient Ta—Re, Mo—Ru alloy film has recently been developed. However, Mo—Ru alloy film can realize the function that no chemical reaction with the glass occurs only under vacuum state, but Mo (also Ta) is vulnerable to oxidation under aerobic environment, leading to coarse molding surface of upper and lower cores, or even glass adhesion.

Alternatively, the reducing gas (e.g.: nitrogen and hydrogen) can be used to protect the mold for molded glass, however, it is restricted by higher cost and bigger space as well as air discharge control and safety considerations. In other words, there is still a room for improvement of existing protection technologies for the mold of molded glass.

### CONTENT OF THE INVENTION

The primary objective of the present invention is to provide a mold for molded glass and its protection method, which enable to generate reducing gas in the molding process of glass, thus protecting the core assembly, extending the service life and reducing the cost and accuracy demand with better applicability.

The present invention provides a protection method of the mold for molded glass, whereby reducing gas is generated within the mold for molded glass to prevent oxidation of core assembly during temperature rise of glass and protect the core assembly; the reducing gas is formed from the reaction between oxygen and carbon-containing element within the mold.

Moreover, the present invention provides a mold for molded glass, which comprises a core assembly consisting of an upper core and a lower core; a core sleeve, arranged on exterior of the core assembly; a carbon-containing reaction member, arranged on exterior of the core sleeve, used to generate reducing gas from reaction with oxygen within the mold during temperature rise of glass, then prevent oxidation of core assembly and protect the core assembly.

### BRIEF DESCRIPTION OF THE DRAWINGS

FIG. 1 is a sketch diagram of first preferred embodiment of the present invention;

FIG. 2 is a sketch diagram of second preferred embodiment of the present invention; and

FIG. 3 is a sketch diagram of third preferred embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

According to the preferred embodiment of the protection method of the mold for molded glass, reducing gas is generated within the mold for molded glass, by means of reaction between oxygen and carbon-containing element within the mold. The carbon-containing element is a graphite sleeve placed on exterior of the core sleeve, or a ring body within the chamber between the upper and lower cores, or a fixed molding ring. A carbon film is coated onto interior of the fixed molding ring.

With this design, the graphite sleeve, ring body or carbon film at interior of fixed molding ring can generate reducing gas (anaerobic conditions) from reaction with the oxygen within the inner space of the mold during temperature rise of glass. In such case, no oxidation occurs at the surface of the core assembly (particularly the molding surface of molded glass), thereby protecting the core assembly and extending the service life of mold.

In other words, the present invention allows the graphite sleeve, ring body or carbon film at interior of fixed molding ring to generate reducing gas from reaction with the oxygen during glass molding process; as compared with conventional mold for molded glass that permits the core surface to be coated with protective precious metal alloy film or diamond like carbon film (DLC), the present invention has lower cost and accuracy demand, without affecting the accuracy of the mold. Secondly, as compared with conventional method that protects the mold for molded glass using reducing gas such as nitrogen+hydrogen or nitrogen+ethylene, the present invention has higher practical value since it addresses the problems of prior art such as: higher cost and bigger space as well as air discharge control and safety considerations.

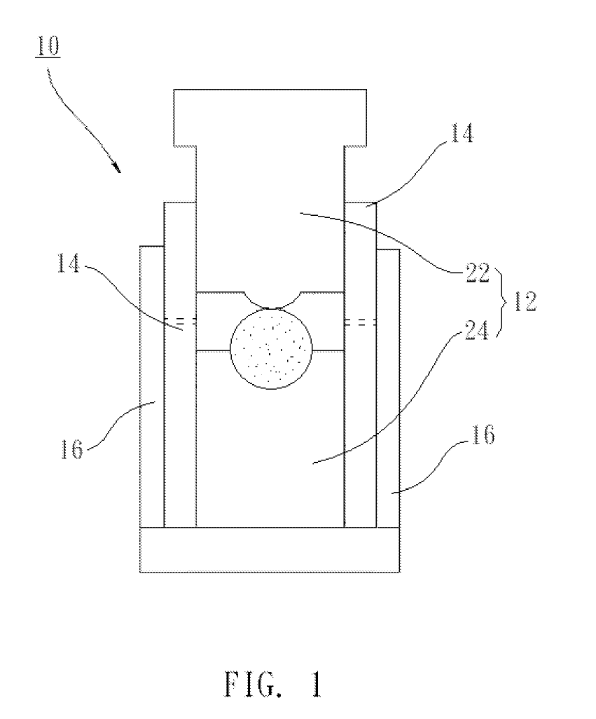

Referring to FIG. 1, the present invention provides a mold 10 for molded glass, which comprises a core assembly 12, a core sleeve 14 and a reaction member 16. The core assembly 12 is provided with an upper core 22 and a lower core 24. The core sleeve 14 is sleeved onto exterior of the upper and lower cores 22, 24. The reaction member 16 made of graphite material is sleeved onto exterior of the core sleeve 14.

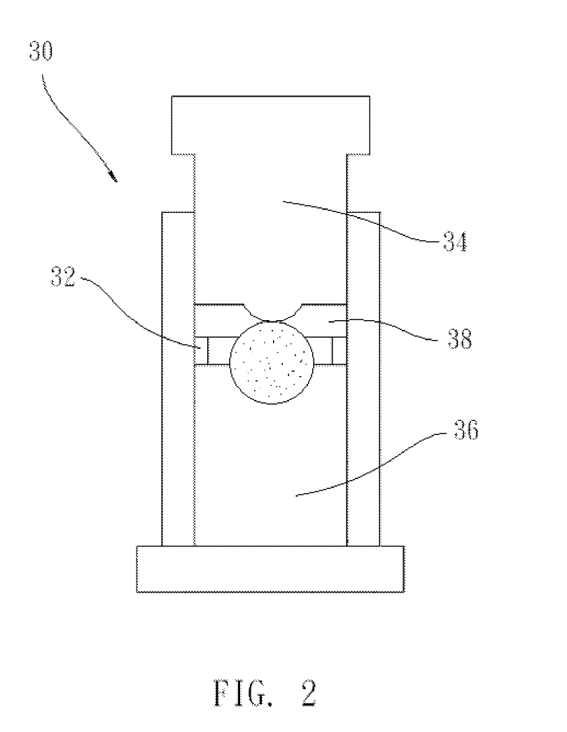

Referring also to FIG. 2, the present invention provides another mold 30 for molded glass, which is structured almost the same with the mold 10; but the reaction member 32 is a ring body placed into the chamber 38 between the upper and lower cores 34, 36.

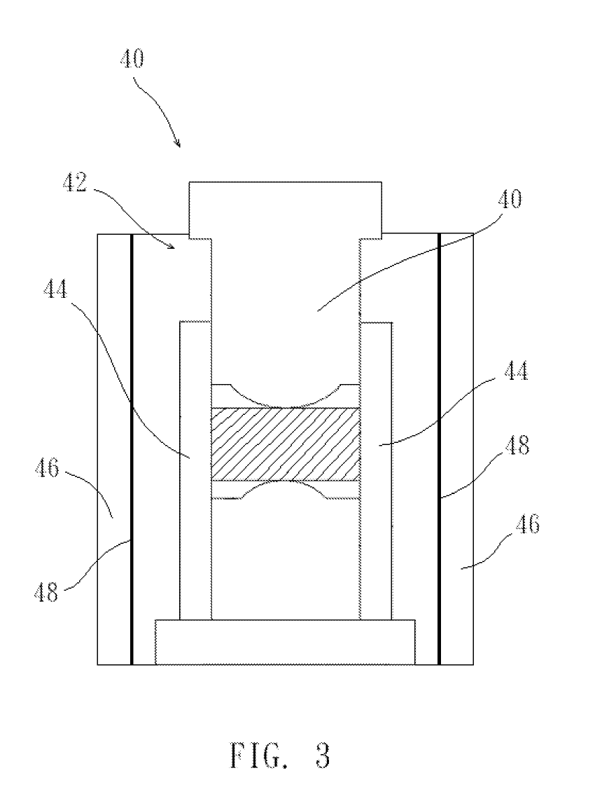

Referring also to FIG. 3, the present invention provides another mold 40 for molded glass, which comprises a core assembly 42, a core sleeve 44 and a fixed molding ring 46. A space is formed between the core assembly 42 and the core sleeve 44, the fixed molding ring 46 is arranged at exterior of the core sleeve 44, with its inner side coated with a carbon film 48.

On the whole, the present invention provides a mold for molded glass and its protection method, whereby the graphite sleeve, ring body or carbon film at interior of fixed molding ring can generate reducing gas in the molding process of glass, thus preventing oxidation of the core assembly, protecting and extending the service life of the mold. As compared with conventional protection method that permits the core surface to be coated with precious metal alloy film or diamond like carbon film (DLC), the present invention has lower cost and accuracy demand, without affecting the accuracy of the mold or without need of discharge control or safe considerations.

What is claimed is:

1. A protection method of the mold for molded glass, which permits reducing gas to be generated within the mold for molded glass, thus preventing oxidation of core assembly during temperature rise of glass and protecting the core assembly; the reducing gas is formed by the reaction between oxygen and carbon-containing element in the mold.

2. The method defined in claim 1, wherein the carbon-containing element is arranged at exterior of the core sleeve of the mold.

3. The method defined in claim 1, wherein the carbon-containing element is arranged within the core assembly of the mold.

4. The method defined in claim 2, wherein the carbon-containing element is a sleeve.

5. The method defined in claim 3, wherein the carbon-containing element is a ring body.

6. The method defined in claim 4, wherein the carbon-containing element is made of graphite material.

7. The method defined in claim 5, wherein the carbon-containing element is made of graphite material.

8. The method defined in claim 1, wherein the carbon-containing element is a fixed molding ring of the mold, onto inner side of which a carbon film is coated.

9. A mold for molded glass, comprising:
a core assembly, consisting of an upper core and a lower core;
a core sleeve, sleeved onto exterior of the core assembly; and
a reaction member, made of graphite material, sleeved onto exterior of the core sleeve, used to generate reducing gas from reaction with oxygen within the mold during temperature rise of glass, then prevent oxidation of core assembly and protect the core assembly.

10. A mold for molded glass, comprising:
a core assembly, consisting of an upper core and a lower core;
a core sleeve, sleeved onto exterior of the core assembly; and
a reaction member, made of graphite material, arranged between the upper and lower cores within the core sleeve, used to generate reducing gas from reaction with oxygen within the mold during temperature rise of glass, then prevent oxidation of core assembly and protect the core assembly.

11. The mold defined in claim 9, wherein the reaction member is a sleeve.

12. The mold defined in claim 10, wherein the reaction member is a ring body.

13. The mold defined in claim 9, wherein the reaction member is made of graphite material.

14. The mold defined in claim 10, wherein the reaction member is made of graphite material.

15. A mold for molded glass, comprising:
a core assembly, consisting of an upper core and a lower core;
a core sleeve, sleeved onto exterior of the core assembly; and
a fixed molding ring, arranged onto exterior of the core sleeve, with its inner side coated with a carbon film.
